(19) United States
(12) Patent Application Publication
(10) Pub. No.: US 2013/0295485 A1
(43) Pub. Date: Nov. 7, 2013

(54) Anode Electro-Catalysts for Alkaline Membrane Fuel Cells

(71) Applicant: CELLERA, INC., Caesarea (IL)

(72) Inventors: Shimshon Gottesfeld, Niskayuna, NY (US); Dario Dekel, Zichron Yaakov (IL)

(21) Appl. No.: 13/888,879

(22) Filed: May 7, 2013

Related U.S. Application Data
(60) Provisional application No. 61/643,509, filed on May 7, 2012.

(51) Int. Cl. H01M 4/92

(52) U.S. Cl. CPC H01M 4/921
USPC 429/482; 429/525; 502/326

(57) ABSTRACT

An anode catalyst for an alkaline membrane fuel cell (AMFC) includes a catalytically active component and a catalytically inactive component, wherein the catalytically active component is selected from one or more of the group of ruthenium (Ru), rhodium (Rh), silver (Ag), osmium (Os), iridium (Ir), platinum (Pt), silver (Ag) and gold (Au)) and wherein the catalytically inactive component is selected from the group of iron (Fe), lead (Pb), nickel (Ni), cobalt (Co) and zinc (Zn).

### RELATED APPLICATIONS

This application is related to U.S. Ser. No. 12/710,539, filed Feb. 23, 2010 for a “Catalyst Coated Membrane (CCM) and Catalyst Film/Layer for Alkaline Membrane Fuel Cells and Methods of Making Same” now U.S. Pat. No. 8,304,368, the entirety of which is incorporated herein by reference. This application is also related to and claims priority to U.S. Ser. No. 61/643,509, filed May 7, 2012, for “Anode Electro-Catalysts for Alkaline Membrane Fuel Cells”, the entirety of which is incorporated herein by reference.

### FIELD OF INVENTION

The present invention relates generally to alkaline membrane fuel cells, and more particularly to an anode electro-catalysts for alkaline membrane fuel cells.

### BACKGROUND

A fuel cell converts chemical energy from fuel (e.g., hydrogen) into electricity through an electrochemical process requiring an oxidizing agent (e.g., oxygen from air). There are many types of fuel cells; but they all are believed to contain an anode, a cathode, and an electrolyte. Electrons are drawn from the anode to the cathode through an external circuit (i.e., the load). The electrolyte allows charged ions (but not electrons) to move between the anode and the cathode within the fuel cell. The electrolyte can be in different forms, such as liquid or membrane.

In a hydrogen/air alkaline membrane fuel cell (AMFC), hydrogen is oxidized at the anode by the following electrochemical process (hydrogen oxidation reaction, or HOR):

H₂+2OH⁻→2H₂O+2e⁻

producing water and electrons. The generated electrons flow through an external circuit (i.e., the load) to arrive at the cathode and are there consumed in the following electrochemical process (oxygen reduction reaction, or ORR):

½O₂+H₂O+2e⁻→2OH⁻,

producing hydroxide ions. The cathode generated hydroxide ions travel through the membrane electrolyte of the AMFC to arrive at the anode. The chemical reactions on the anode and the cathode will run continuously as long as the gaseous reactants (H₂ and O₂) are supplied. The net cell reaction consumes oxygen and hydrogen and produces water, generating electrons to drive an external load. Heat is also generated as a by-product.

### SUMMARY OF INVENTION

This invention is related to an earlier filed application, namely,: “Catalyst Coated Membrane (CCM) And Catalyst Film/Layer For Alkaline Membrane Fuel Cells And Methods Of Making Same”, U.S. Ser. No. 12/710,539, filed Feb. 23, 2010, now U.S. Pat. No. 8,304,368 which discloses the preparation of a catalyst coated membrane (CCM) for use in an alkaline membrane fuel cell (AMFC) comprising: an anion conducting alkaline membrane; and a catalyst layer applied adjacent the membrane, wherein the catalyst layer comprises: (a) a metal nano-powder; and (b) an ion conducting ionomer In particular, the earlier application disclosed that silver-containing nano-powders may be used as a metal catalyst component , particularly for the AMFC cathode. The earlier application also discloses fabrication of an anode catalyst layer for an AMFC using unsupported, metal nano-particles mixed with an ion-conducting ionomer.

A particular aspect of the present invention is an extension of the family of metal nano-powders employed for such catalyst layer preparation to intermixed active and non-active metal nano-particles as well as the use of additional catalytically active metals including: ruthenium (Ru), palladium (Pd), rhodium (Rh), osmium (Os), Iriduim (Ir), platinum (Pt), and gold (Au) in addition to silver (Ag) particles.

Use of unsupported metal nano-particles as catalysts in fuel cells is not believed to be the usual choice of materials. This is because supported, typically carbon-supported metal catalysts are a preferred choice in most cases. However, the AMFC presents a high challenge of limited ionic conductivity within the catalyst layer at some given ionomer content and, consequently, the thinness of the catalyst in an AMFC is of special value. To meet the goal of packaging a sufficiently large catalyst surface area within a catalyst layer of minimum thickness, an unsupported layer of metal nano-particles has a clear advantage over carbon-supported metal catalysts. Consequently, the average distance traveled by the ionic species through the former type layer will be shorter and the ionic conduction losses which are dominant in AMFCs can thereby be lowered. On the other hand, a challenge posed by the dense packing of catalyst layers made of unsupported , nano-sized metal catalysts, is insufficient pore networks required for effective transport of ionic charge, water and gaseous reactants. Resolution of this challenge is a prerequisite for successful implementation of such catalyst layers in AMFC technology and it calls for optimized catalyst compositions achieved by optimized content of the ionomeric component in the layer and, as taught in this Invention, additions of non-active nano-particles to the formulation of the catalyst layer.

In general, in an aspect, the invention provides an anode catalyst for an alkaline membrane fuel cell (AMFC) that includes a catalytically active component and a catalytically inactive component, wherein the catalytically active component may be selected from one or more of the group of ruthenium (Ru), iridium (Ir), platinum (Pt), rhodium (Rh), silver (Ag), osmium (Os), gold (Au) and palladium (Pd) and wherein the catalytically inactive component may be selected from one or more of the group of iron (Fe), nickel (Ni), silver (Ag), carbon (C), cobalt (Co), zinc (Zn) and lead (Pb).

In general, in another aspect, the invention provides an anode catalyst for an alkaline membrane fuel cell (AMFC) made from palladium (Pd).

In general, in yet another aspect, the invention provides an anode catalyst for an alkaline membrane fuel cell (AMFC) made from a palladium-nickel (Pd-Ni) alloy.

In general, in yet another aspect, the invention provides an anode catalyst for an alkaline membrane fuel cell (AMFC) made from a mechanical mixture of palladium (Pd) and nickel (Ni) particles.

In general, in yet another aspect, the invention provides an alkaline membrane fuel cell (AMFC) that includes an anode having an anode catalyst, a cathode having a cathode catalyst, and an electrolyte.

Implementations of the present invention may provide one or more of the following features. The anode catalyst may be made from palladium (Pd). Alternatively, the anode catalyst may be made from a palladium-nickel (Pd—Ni) alloy. In addition, the anode catalyst may be made from a mechanical mixture of palladium (Pd) and nickel (Ni) particles.

Various aspects of the invention can provide effective and low cost anode catalysts for alkaline membrane fuel cells (AMFCs).

These and other capabilities of the invention, along with the invention itself, will be more fully understood after a review of the following figures, detailed description, and claims.

### BRIEF DESCRIPTION OF THE FIGURES

FIG. 1 show voltage-current density curve and power-current density curve of an AMFC with a Pd anode catalyst according to one embodiment of the invention.

FIG. 2 show voltage-current density curve and power-current density curve of an AMFC with a Pd—Ni alloy anode catalyst according to one embodiment of the invention.

FIG. 3 show voltage-current density curve and power-current density curve of a Pd—Ni mechanical mixture anode catalyst according to one embodiment of the invention.

### DETAILED DESCRIPTION

Embodiments of the invention can provide an anode catalysts in an AMFC having effective catalytic characteristics and yet relatively low cost. Other embodiments are within the scope of the invention.

Catalysts are commonly used in chemical reactions and in fuel cells to improve reaction rates and increase fuel cell performance. The performance of catalysts can be improved when they are supported by another material (e.g., carbon), which helps to provide high surface area and reduce agglomeration of catalysts. But supported catalysts may be less stable than unsupported catalysts because the catalyst support (e.g., carbon) may be vulnerable to external environment , for example suffering oxidative mass loss, particularly when near open circuit conditions and under higher cell temperatures. Thus, using unsupported catalysts may help to extend the fuel cell's lifespan.

Noble metals (e.g., precious metals such as platinum (Pt)) have been used as an anode catalysts in fuel cells because these metals generally have a high adsorption affinity to H atoms and a relatively low adsorption affinity to O atoms and/or other oxygen-containing species. These attributes are desirable for a HOR process because high concentration and proper stabilization of adsorbed H atoms improve the rate of the HOR process whereas surface O atoms and other oxygen-containing surface species deactivate the surface vs. the HOR. However, the high cost and price volatility of precious metals (e.g., Pt at $500-$2500/oz) has hindered the development of fuel cell technologies based on such catalysts. Unalloyed base metals (e.g., iron (Fe) or nickel (Ni)), although inexpensive, generally do not work well as an anode catalysts because oxygen-free surfaces are difficult to be sustained for these metals , especially when the fuel cell is under current.

We have discovered that Palladium (Pd), which is also a noble metal, can be an effective low-cost alternative to Pt as AMFC anode catalyst. Pd's affinity to surface oxygen is slightly higher than that of Pt; but its market price is currently only about ⅓ that of Pt.

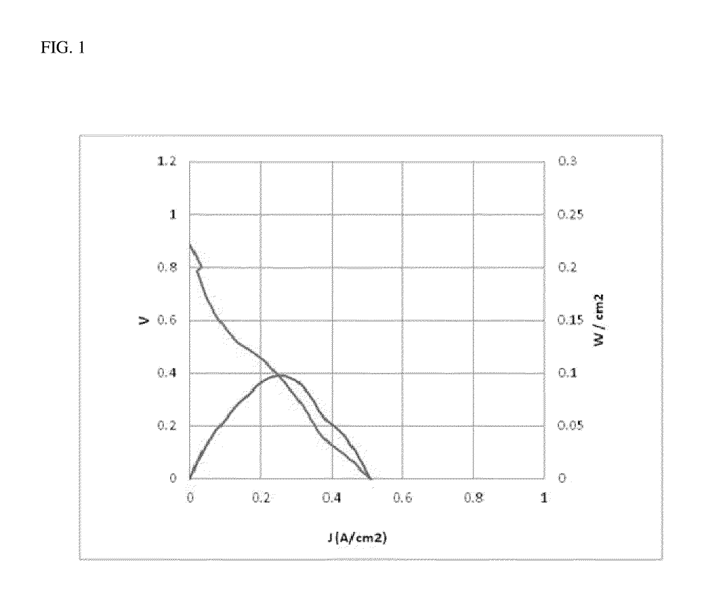

FIG. 1 demonstrates testing results of using unalloyed Pd nano-particles as an anode catalyst in a hydrogen/air Pt-free AMFC. Unsupported silver alloy is used as a cathode catalyst in this hydrogen/air AMFC. Both voltage-current density curve and power-current density curve are shown in FIG. 1.

As illustrated in FIG. 1, significant catalytic activity is obtained , showing that the unalloyed Pd nano-particles can catalyze the HOR process on the anode. The power density peaks in this case at 0.1 W/cm²; the maximum current density can reach 0.5 A/cm².

Some specific alloying of Pd can be used to improve the performance of the anode catalyst . The inventors pursued an approach described before for platinum cathode catalysts in acidic (proton conducting) polymer electrolyte fuel cells (PEFCs). See, for example, Jia X. Wang, Hiromi Inada, Lijun Wu, Yimei Zhu, YongMan Choi, Ping Liu, Wei-Ping Zhou and Radoslav R. Adzic J. Am. Chem. Soc., 2009, 131 (47), pp 17298-17302

One example of alloying Pd is to alloy Pd with a non-noble metal (e.g., cobalt (Co) or nickel (Ni)). The alloyed particles can have a mono-atomic surface (shell) very rich in Pd and a core relatively rich in the non-noble metal (e.g., Co or Ni). The Pd-shell-on-Ni-core structure can be achieved by galvanic displacement of Ni atoms on a Ni particle by Pd atoms, as reported by R. Adzic of BNL in the 2011 AMR meeting of the DOE , in Washington, DC. This “shell-on-core” structure can help to make the shell atoms (e.g., Pd) more “noble” than those same atoms on the surface of an unalloyed Pd metal particle. The improved “nobility” of such a shell-on-core structure comes about because the Pd shell atoms , when on a nickel core, would become less prone to 0 species adsorption and , consequently, less deactivated by oxygen-containing species in the HOR process. Alloying (e.g., Ni—Pd) can also help lower the cost of Pd-based anode catalyst.

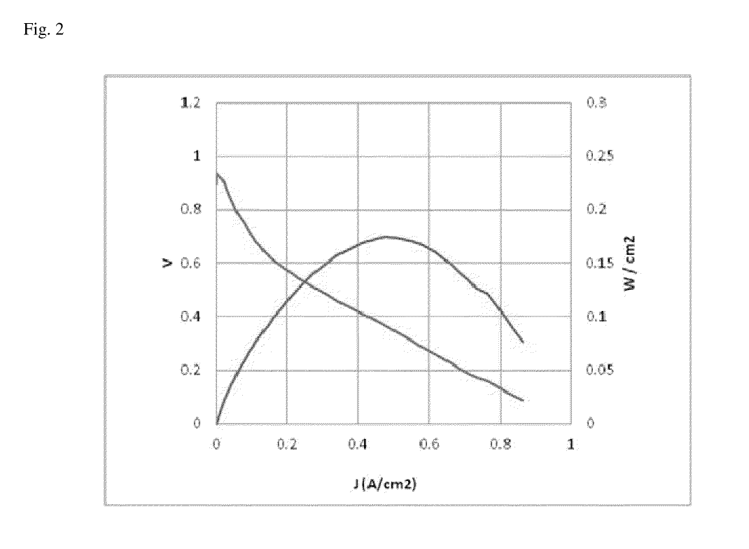

FIG. 2 demonstrates testing results for a hydrogen/air Pt-free AMFC using Ni—Pd (1:1) alloy nano particles as an anode catalyst. Unsupported silver alloy is used as a cathode catalyst in this hydrogen/air AMFC. Both voltage-current density curve and power-current density curve are shown in FIG. 2.

As illustrated in FIG. 2, better catalytic activity is obtained, compared to using the unalloyed Pd nano particles as an anode catalysts (FIG. 1). The power density peaks at 0.17 W/cm², representing a 70% increase over the unalloyed Pd catalyst; the maximum current density can reach almost 1 A/cm², representing an almost 100% increase over the unalloyed Pd catalyst.

Surprisingly, catalyst compositions achieved by simple, mechanical mixing of nano-particles of Pd with nano-particles of another metal, exhibited even better improvement of the performance over that of a neat Pd anode catalyst. One exemplary way to perform mechanical mixing is to simply mix Pd nano-particles with non-noble metal (e.g., Co or Ni) nano-particles. The mechanical mixing can be performed without any recourse to high energy during the mixing process (e.g., ball milling), for example by applying ultrasound perturbation to a dispersion of a mixture of metal particles in a solvent.

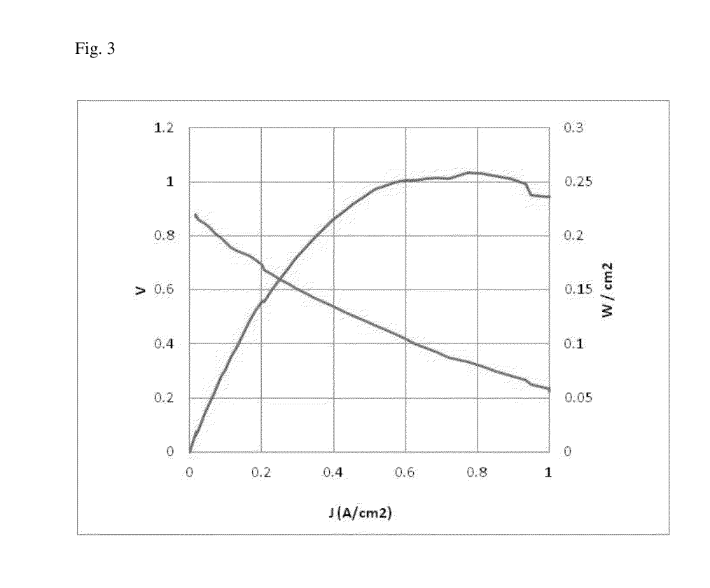

FIG. 3 demonstrates testing results for a hydrogen/air Pt-free AMFC using mechanical mixture of Ni and Pd nano particles as an anode catalyst. An unsupported silver alloy was used as a cathode catalyst in this hydrogen/air AMFC. The voltage-current density curve and power-current density curve are shown in FIG. 3 for a PdNi mechanical mixture of atomic ratio 1:1.

As seen in FIG. 3, the power density peaks at 0.26 W/cm², representing a 160% increase over the unalloyed Pd catalyst; the maximum current density can reach near 1.5 A/cm², representing an almost 200% increase over the unalloyed Pd catalyst.

Following mechanical mixing, the catalytically inactive particles (e.g., Ni) may re-define the morphology (e.g., the packing configuration) of the catalyst layer. The catalytically inactive particles of different forms and sizes may help generate a less densely packed catalyst layer which can be beneficial to the transport of water and/or oxygen through the catalyst layer. In other words, mechanical mixing of two different kinds of nano-particles may “open-up” the catalyst layer structure and generate critical transport routes. Thereby, the mechanical mixing with catalytically inactive nano-particles may serve the same function as that provided by a catalyst support (e.g., carbon), in defining the catalyst layer morphology on the micrometer scale and thereby increasing the effective (accessible) surface area of the catalytically active nano-particles. The mechanical mixing (e.g., Ni—Pd mixture) of catalytically inactive nano-particles can also help lower the cost of a Pd-based anode catalyst. The catalytically active nano-particles of a mixture can be alloyed themselves; the catalytically inactive nano-particles of a mixture can also be alloyed themselves.

Further improvements in catalytic activity may be obtained by using metal nano-rods (nano wiskers) of Ni, Co, or Fe or any of the other catalytically inactive components discussed above. These structures can be prepared by colloidal or reverse micelle routes and can be alloyed with Pd or coated with a thin layer of Pd.

The dispersed catalysts discussed above (e.g., Pd, PdNi alloy, Pd—Ni mixture) are used to prepare the catalyst ink which can be applied to an ionomeric membrane of an AMFC. The catalyst ink can be prepared without any solid component other than high surface area metal particles which can be dispersed ultrasonically in a proper solvent allowing satisfactory bonding of the catalyst ink to the surface of the anion-conducting membrane. The catalyst ink can contain an optimized weight of dissolved ionomer that recasts on application of the catalyst ink to the membrane surface. More details can be found in the aforesaid U.S. parent application U.S. patent application Ser. No. 12/710,539, titled “Catalyst Coated Membrane (CCM) and Catalyst Film/Layer for Alkaline Membrane Fuel Cells and Methods of Making Same”, filed Feb. 23, 2010, now U.S. Pat. No. 8,304,368.

The illustration of Pd-Ni based catalyses (Pd alone, PdNi alloy, or Pd-Ni mixture) should not be viewed as to limit the materials that can be used to form an anode catalyst layers in AMFCs. Materials with similar characteristics can also be used to form an anode catalyst layers in AMFCs. For example, other highly dispersed noble metals (e.g., ruthenium (Ru), rhodium (Rh), silver (Ag), osmium (Os), iridium (Ir), platinum (Pt), and gold (Au)) or alloys thereof, can be the catalytically active component of an AMFC anode catalyst layer ; other base metals (e.g., iron (Fe), lead (Pb), and zinc (Zn)) or any of the other catalytically inactive components discussed above or alloys thereof, can be the catalytically inactive component of the anode catalyst. Various other combinations of catalytically active materials and catalytically inactive materials can also be used to form an anode catalysts in AMFCs.

While the description above refers to the invention, the description may include more than one invention. In addition, although the description above sometimes uses the term “alkaline membrane fuel cell” or AMFC, the invention is not so limited. The invention disclosed herein may apply to other fuel cell technologies or other technology fields.

It is noted that one or more references may be incorporated herein. To the extent that any of the incorporated material is inconsistent with the present disclosure, the present disclosure shall control. Furthermore, to the extent necessary, any material incorporated by reference herein should be disregarded if necessary to preserve the validity of the claims.

What is claimed is:

1. A catalyst for an alkaline membrane fuel cell (AMFC), comprising:
a catalytically active component; and
a catalytically inactive component;
wherein the catalytically active component is made of highly dispersed, unsupported metal particles, with the metal selected from one or more of the group of ruthenium (Ru), palladium (Pd) rhodium (Rh), silver (Ag), iridium (Ir), osmium (Os), platinum (Pt), gold (Au) and alloys thereof;
and wherein the catalytically inactive component is made of highly dispersed, unsupported metal particles, with the metal selected from one or more of the group of iron (Fe), nickel (Ni), carbon (C), cobalt (Co), lead (Pb) and zinc (Zn) and alloys thereof.

2. An anode catalyst for an alkaline membrane fuel cell (AMFC) containing palladium (Pd) or a Pd alloy as the catalytically active component.

3. An anode catalyst for an alkaline membrane fuel cell (AMFC) made from one of:
a palladium-nickel alloy (PdNi);
a mechanical mixture of palladium (Pd) and nickel (Ni) particles;
particles of Pd shell-on-transition metal core (Pd shell particles); and
a mechanical mixture of Pd shell-on-transition metal-core particles (Pd shell) and nickel (Ni) particles.

4. An alkaline membrane fuel cell (AMFC), comprising:
an anode with an anode catalyst layer;
a cathode with a cathode catalyst layer; and
an anion-conducting membrane electrolyte,
where each catalyst layer is applied to the membrane surface by spraying , casting or screen-printing a catalyst ink comprising a solvent , dissolved ionomer and a dispersed unsupported metal catalyst wherein the unsupported metal catalyst is a catalytically active component selected from one or more of ruthenium (Ru), palladium (Pd), rhodium (Rh), silver (Ag), iridium (Ir), platinum (Pt), gold (Au) and alloys thereof.

5. The alkaline membrane fuel cell (AMFC) of claim 4, wherein the anode catalyst contains palladium (Pd) as the catalytically active component.

6. The alkaline membrane fuel cell (AMFC) of claim 4, wherein the anode catalyst is made of a palladium-nickel alloy (PdNi).

7. The alkaline membrane fuel cell (AMFC) of claim 4, wherein the anode catalyst is a mechanical mixture of palladium (Pd) and nickel (Ni) particles.

8. The alkaline membrane fuel cell (AMFC) of claim 4, further comprising a catalytically inactive compound selected from one or more of iron (Fe), nickel (Ni), carbon (C), cobalt (Co), zinc (Zn), lead (Pb) and alloys thereof.

9. The alkaline membrane fuel cell (AMFC) of claim 4, wherein the anode catalyst is comprised of metal nano-particles surface-decorated by another, catalytically active metal.

10. The alkaline membrane fuel cell (AMFC) of claim 4, where the catalyst is made of nickel nano-particles surface decorated by palladium (Pd) nano-particles.
